(19) United States
(12) Patent Application Publication
(10) Pub. No.: US 2012/0298914 A1
(43) Pub. Date: Nov. 29, 2012

(54) Method for Treating and Conditioning Tailings

(75) Inventor: Timothy J. Laros, Park City, UT (US)

(73) Assignee: FLSMIDTH A/S, Valby (DK)

(21) Appl. No.: 13/576,984

(22) PCT Filed: Feb. 3, 2011
(86) PCT No.: PCT/US11/23587

§ 371 Date: Aug. 3, 2012

Related U.S. Application Data
(60) Provisional application No. 61/301,277, filed on Feb. 4, 2010.
(60) Provisional application No. 61/424,764, filed on Dec. 20, 2010.

(51) Int. Cl. B01J 20/30

(52) U.S. Cl. 252/194

(57) ABSTRACT

A sludge or slurry physical stabilizing method combines coarse particles with a slurry of fine particles to generate a composite slurry having a substantially predetermined ratio of coarse particles to fine particles. The composite slurry can then be diluted, flocculated and/or dewatered. Superabsorbent polymer (SAP) is mixed in with the dewatered composite slurry in an amount effective to produce a shear stable, non-segregating conveyable composition of sufficient strength to enable pumping, transport and placement at a mining site or tailings disposal site.

### BACKGROUND OF THE INVENTION

The present invention relates to a method for treating and conditioning tailings in order to facilitate the transport, disposal and deposition of the tailings. The tailings in question could originate from any number of processes, including, but not limited to, various mining operations and the term tailings could also encompass various sludges and other liquid/solid materials that need to be dewatered and transported.

For example, during the extraction of oil from oil sands ore, the raw material extracted from the earth generally comprises about 85% sand and clay, 10% oil or bitumen (tar), and 5% water. This material is generally processed by mixing the ore with hot water, with the bitumen froth rising to the top and floated off. After removal of the bitumen, the bitumen depleted slurry generally containing various mixtures of coarse solids, sand, silt, clay and water are generally considered oil sands tailings. It is desired to dispose of the oil sands tailings so as to minimize impact on the environment. It is further desired and sometimes even required to restore the land to a semblance of its original condition before the mining.

Generally, oil sand deposits are located beneath the surface. The mining process initially entails stripping an overburden from the surface to expose the target oil sand ore beneath. The overburden can be placed to the side and then returned to the site once the target sand deposit is removed. One object is to restore the processed tailings back to the site and to place the overburden over the tailings from which the bitumen has been extracted. The replaced tailings must consolidate to the point of having sufficient strength to support the original overburden without generating sink holes and depressions that were not present in the original landscape. Another object of environment restoration is to use the original material as much as possible to avoid carting in landfill from other areas.

In the current state of the art, oil sands tailings are deposited in slurry form in artificial ponds for drying. In one such process, depicted in FIG. 1, a tailings slurry stream 10 that is about 77% water is conveyed from an extraction plant 12 to a cyclone separator 14. Coarse sand particles 16 exit separator 14 at an outlet 18 and are used to build pond berms 20. A slurry stream of fine tailings 22 is delivered from separator 14 to a gravity sedimentation device 24 known as a thickener. Thickener 24 produces a thickened slurry 26 that is mixed with gypsum, sands and flocculant 28 in a blending device or mixer 30 and then conveyed to a settling and drying pond 32. Pond 32 is dredged to capture the settled solids, known as mature fine tailings or MFT, which are then blended with additional flocculant and deposited in a thin film in a drying bed with enhanced drainage. The deposited film may be churned or “farmed” by bulldozers to accelerate evaporation. The dried materials may then be transported back to the excavation site and covered with a previously sidelined overburden in an attempt to return the land to its original condition.

Disadvantages of the current methods for processing fine sand tailings are that the high concentrations of water in the slurries require a substantial amount of time for drying and consolidation to transform the fine tailings materials to a trafficable state. The time to dry tailings is generally no less than 30 days. Moreover, the drying process entails significant costs, for instance, in managing the drying beds. Moreover, the end result is usually not trafficable or conveyable without the use of additional filters, centrifuges or sand in excess of the quantities available on site.

Another current method for disposing of oil sands tailings in particular is known as composite tails or CT. In this method, the mature fine tailings or MFT are dredged from existing tailings ponds and combined with sand in ratios from 1:1 to 4:1 or greater sands to fines ratios and flocculated to produce what is known as non-segregating tails or NST. The NST is then pumped to a dedicated disposal area or DDA where the NST should consolidate over time to produce a disposal area that is trafficable and amenable to reclamation.

This method works to a limited extent in that the structure of the CT material breaks down, mostly due to the shear encountered during the pumping, transport and deposition process, essentially rendering the tailings no longer non-segregating. In a segregating state, the tailings do not consolidate to the degree necessary to achieve trafficability and proper reclamation. Hence, this method has limited practical application.

One recently devised method for reducing free water content in clarification processes involves the use of superabsorbent polymers (SAP). These synthetic polymers are a class of cross-linked, non-biodegradable polymers capable of absorbing and retaining up to 500 times their weight in water. They dissolve in water, forming “fish nets” of entangled linear molecules, with molecular weights in the millions, which work in part to agglomerate and precipitate unwanted solids from water. These water-soluble polymers are generally available in dry particulate or granular form, although other forms such as gels, powders, suspensions, emulsions, crystals, fibers, etc., can be found and used. Upon being placed in contact with an aqueous solution or slurry, the surfaces of the dry polymeric particulates dissolve in successive layers. The size of the particle determines only the time of dissolution.

Superabsorbent polymers are produced by adding to a reaction mixture of the linear polymers cross-linking agents which form two- and/or three-dimensional bonds between the linear molecules. The cross-linking immobilizes the linear molecules. Their affinity for water is not reduced but now the water must be absorbed within the cross-linked structure. The particular structure does not change in shape as it absorbs water but simply swells while retaining the same relative dimensional configuration. The ultimate size of the hydrated superabsorbent particle is a function of its size in the dry state. The rate of water absorption of the surface superabsorbent particle is the same as for the surface of the linear building blocks. However, because the surface layer does not dissolve and move away from the particle's surface, the rate of water penetration of the cross-linked polymer is much slower than the rate of dissolution of the linear polymer. As a result, the rate of water uptake is affected by particle size impeded by the cross-linked structure.

Superabsorbent polymer has been used in processes for forming ore pellets, as discussed in U.S. Pat. No. 5,112,391, and in the drying of coal fines, as disclosed in the article “Dewatering of Coal Fines Using a Superabsorbent Polymer”, The Journal of the South African Institute of Mining and Metallurgy, July/August 2003, pp. 403-409. More generally, SAP is widely used in the environmental industry to treat many types of aqueous wastes. The advantage of these water-swellable superabsorbent polymers is that they can absorb many times their weight in water with nominal or negligible increase in waste volume or weight.

### SUMMARY OF THE INVENTION

The present invention aims to provide a method for modifying the rheology or physical stability of, and thereby stabilizing or conditioning, a fine-particle slurry such as a slurry of fine oil sands tailings such as CT by absorbing a certain amount of free water thus making the resulting slurry resistant to shear induced breakdown due to the pumping and transport of the same, thus producing truly non-segregating and stable material when it is placed in a disposal area. The invention seeks to produce a flowable, yet shear and segregation resistant composition that may be easily transported by pumps and pipelines. The present invention will facilitate the restoration of mined land to its original condition prior to dislocation for oil extraction purposes, without requiring landfill from a distant supply.

A sludge or slurry stabilizing or conditioning method in accordance with the present invention comprises combining coarse particles with a slurry of fine particles to generate a composite slurry having a substantially predetermined ratio of coarse particles to fine particles and subsequently mixing superabsorbent polymer (SAP) with the composite slurry in an amount effective to produce a pumpable, yet shear resistant, non-segregating composition.

In accordance with another feature of the present invention, the method may further comprise dewatering the composite slurry prior to the mixing of the superabsorbent polymer with the dewatered slurry. It is also contemplated that the dewatering of the composite slurry may include diluting and flocculating the composite slurry and then processing the composite slurry in a dewatering device. The dewatering device may be any dewatering machine or equipment, e.g., a gravity thickener, a clarifier, a paste thickener, a gravity belt thickener, a belt press, a screen, a sieve bend, a DSM screen, a vacuum assisted screen, a filter thickener, a washing thickener, a centrifuge or any combination thereof.

As part of the dewatering step, or otherwise as a separate step in the contemplated process, the pH of the slurry may be adjusted with a suitable base or acid, such as lime, caustic, or weak acid, at various steps in the process prior to the addition of the SAP Likewise, the hardness of the slurry and/or of any added liquid such as the dilution water may be adjusted and optimized. The slurry may also be variously washed as part of, or separate from, the present process, for example, as part of the dewatering step and in the dewatering device, to remove undesirable elements, such as chloride salts, prior to the addition of the SAP. Furthermore, depending on the slurry and the optimization of the process, other conditioning of the slurry at various parts of the process can also take place; for example, agglomeration of clay particles prior to flocculation may be desired.

Preferably, the predetermined ratio of coarse grains to fine grains is between about 0.5 and about 4 or greater by weight. More preferably, where the fine particles are oil sands tailings and the coarse particles are sand grains, the predetermined ratio is between about 1 and about 4 or greater by weight. Most preferably in such a case, the predetermined ratio is between about 2 and about 4 or greater by weight.

The method may further comprise generating the slurry of fine tailings from an extraction slurry by separating out coarse sand particles from the extraction slurry. In that event, the coarse particles combined with the slurry of fine tailings to produce the composite slurry may be derived from the coarse sand particles separated from the extraction slurry.

In accordance with a further feature of the present invention, the mixing of superabsorbent polymer with the composite slurry includes adding a semi-solid composition of at least somewhat dried solids including at least somewhat dried, regenerated or reconditioned superabsorbent polymer to the composite slurry. This added composition is a feedback portion of the output semi-solid composition and it serves to reduce the amounts of coarse sand and new or fresh SAP needed for the process. The adding of the semi-solid composition is then a recycling of the semi-solid composition.

Generally, the method of the present invention contemplates several machines at different stations respectively carrying out the processes of (a) mixing the coarse particles with the fine particle slurry to generate the composite slurry, (b) dewatering the composite slurry, (c) mixing the SAP in with the dewatered slurry, and (d) depositing the treated or conditioned composition at a disposal station. The sludge may be conveyed from the thickening station to the SAP mixing station by pipeline. The treated or conditioned composition at the output of the SAP mixing station may generally be conveyed from the SAP mixing station to the disposal station by pumping, pipe conveyor or pipeline.

Where the process is used to treat oil sands tailings, particles in the slurry of fine particles have a diametrical size in a range less than about 44 microns, whereas the coarse particles have a diametrical size in a range greater than about 44 microns. The slurry of fine particles may include mature fine tailings, new fine tailings, whole tailings and/or composite tailings from any number of various processes and industries including, but not limited to, the mining and/or extraction of oil sands, coal, clays, red mud, phosphates, and fly ash.

In a specific embodiment of the present invention, a method for dewatering oil sands tailings comprises combining fine tailings—generally either mature fine tailings (MFT) or new fine tailings (NFT)—having a particle size of less than about 44 microns with coarse sand tailings having a particle size greater than about 44 microns so that a ratio of coarse sand particles to fine sand particles of about 0.5 to 4, by weight, is achieved. The method further comprises diluting the composite slurry, flocculating the composite slurry and dewatering the composite slurry in a gravity sedimentation device known as a thickener or other device to a paste consistency. The method may further also include adjusting the pH of the slurry and/or the resulting paste and/or washing the slurry and/or the resulting paste.

The paste can then be transported by pipeline closer to a disposal area where a sufficient quantity of superabsorbent polymer (SAP), in this case usually in particulate or granular form, although other forms of SAP such as gels, powders, suspensions, emulsions, crystals, fibers, etc. could be used, is added to the paste to generate a shear resistant, flowable product. A mixing device, e.g., a blender, pump, mixer, agglomerator, extruder or pug mill, mixes the SAP into the paste to produce the stabilized, shear resistant slurry material. The slurry material may then generally be deposited in a disposal area by a pump and pipeline system, perhaps including a floatable dredge. In addition, such deposited and partially dried material may be recovered and back mixed with the composite or other slurry, as the case may be, to reduce the quantity of sand and SAP required.

The addition of the coarse sand particles to a fine tailing slurry in a proper ratio is deemed necessary in order to generate a sufficient amount of appropriately sized pores or interstices that facilitate the entry of the SAP into, and/or mixing with, the composite or other slurry, as the case may be, and causing the water to be tied up or bound in a manner to thereby produce a shear resistant, pumpable material.

The present invention enables the use of numerous pumps, pipelines and/or other placement devices as may be necessary to move the processed tailings from the processing station to temporary and/or permanent storage or rest locations.

The present invention can be used with new tailings, straight from the extraction process, or mature tailings that may have settled in treatment pods. Ultimately, however, the present invention contemplates the better utilization of disposal areas, thus reducing costs as well as accelerating the tailings processing time from the point of extraction to the point of deposition back to the original location on the land or other rest location.

These and further objects and features of the present invention will become readily apparent to those skilled in the art after consideration of the ensuing description and the accompanying drawings

### BRIEF DESCRIPTION OF THE DRAWINGS

FIG. 1 is a flow diagram of a conventional process for treating oil sands tailings.

FIG. 2 is a flow diagram of a process for treating oil sands tailings in accordance with the present invention.

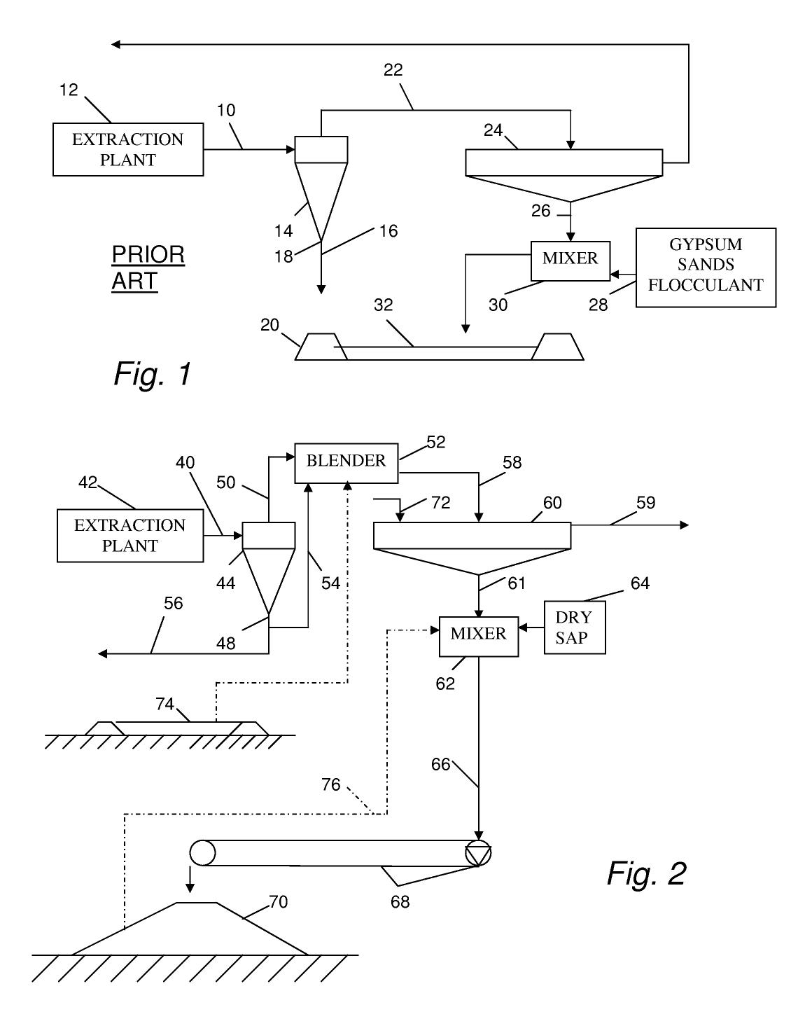

### DETAILED DESCRIPTION

Throughout the following description, specific details are set forth in order to provide a more thorough understanding of the invention. However, the invention may be practiced without one or more of these particulars. In other instances, well known elements have not been shown or described to avoid unnecessarily obscuring the invention. Accordingly, the specification and drawings are to be regarded in an illustrative, rather than in a restrictive, sense.

FIG. 2 depicts a method for physically stabilizing a slurry of fine oil sands tailings. The illustrated process produces a slurry composition that has sufficient stability such that the structure of the combined sands and fines can withstand the shearing forces caused by pumping and pipeline transport and be, and remain, non-segregating when placed in a disposal area.

As shown in FIG. 2, a tailings slurry stream 40 that is about 77% water is conveyed from an extraction plant 42 to a cyclone separator 44. Coarse sand particles exit separator 44 at an outlet 48. A slurry stream 50 of fine tailings from cyclone separator 44 is combined in a mixer or blender apparatus 52 with coarse particles 54 conveyed in a slurry stream from outlet 48 of the separator. Excess coarse sand particles are conveyed or pumped away at 56, for instance, back to the mining site.

The particles in slurry stream 50 have a diametrical size in a range of less than about 44 microns, whereas the coarse particles 54 have a diametrical size in a range greater than about 44 microns.

A composite slurry stream 58 is then usually flocculated, as generally well known in the art, by adding any suitable flocculation reagent, for example, Hychem AF 306 HH sold by Hychem Inc. of Tampa, Fla. (www.hychem.com), passes from mixer 52 to a dewatering or separation apparatus 60. Dewatering or separation apparatus 60 produces a clarified water output 59 and a thickened slurry 61 of a paste consistency that is fed to a mixer 62 and mixed therein with superabsorbent polymer (SAP) 64 in a sufficient amount to produce a generally stable, non-segregating composition 66 that is flowable, yet resistant to shear. This resultant composition 66 may be conveyed by a pipe conveyor 68 or pumped by a pump 68 through a pipeline 68 to a stacking or disposal station 70.

The SAP added in this particular embodiment is usually of a particulate or granular form, although other forms of SAP, such as gels, powders, suspensions, emulsions, crystals, and/or fibers could be used. For this particular embodiment, such SAP particles would generally be added in a ratio of about 0.2 to 5 lbs. by weight of dry solids in with the thickened paste 61.

The sludge or slurry physical stabilizing process depicted in FIG. 2 entails combining coarse particles 54 with fine tailings slurry 50 so as to generate composite slurry 58 having a substantially predetermined ratio of coarse particles to fine particles. A proper ratio of coarse sand particles 54 to fine grains in composite oil sands slurry 58 is critical to achieving a non-segregating tailings over the addition of SAP alone. Preferably, the ratio of coarse grains to fine grains in composite oil sand slurry 58 is between about 0.5 and about 4 by weight. Outside of this range, the process is still effective to create NST over the mere addition of SAP alone; however, the tailings may not consolidate to a trafficable state in the disposal area. More preferably, the ratio is between about 1 and about 4. Within this range, the process is satisfactory in producing a sufficiently consolidating product within a reasonable time period without the excess consumption of sand. Most preferably the ratio of coarse grains to fine grains is between about 2 and about 4. Within this range the process is generally optimized.

It is also contemplated that the dewatering of composite slurry 58 in dewatering or separating apparatus 60 may include adding reagents such as various conditioners, flocculants and/or coagulants 72 to accelerate the separation process. Also, water may be added to composite slurry stream 58 to dilute the slurry prior to the flocculation and subsequent water extraction in dewatering or separating apparatus 60. In addition, the dewatering apparatus 60, for example, a washing thickener, may include further and various equipment such as washers for washing the incoming slurry stream 58 in order to remove any undesirable elements. The dewatering apparatus 60 may, therefore, include one or more actual additional pieces of variously cooperating equipment.

Furthermore, if the pH of the slurry or paste is an issue, the same can be adjusted prior to the SAP addition. For example, either or both slurry streams 58 and 61 could have their pH adjusted as desired for better SAP admixing and drying efficacy. Likewise, the slurry streams 58 and 61 could be further washed of any undesirable parts or elements and the hardness of the various streams and liquids adjusted.

The present invention may be used in the dewatering of many different types of particle-laden sludges or slurries including, but not limited to, slurries of fine tailings. Dewatering or separating apparatus 60 may take any suitable form or forms, depending on the particular application. In the case of oil sands tailings, a gravity sedimentation device is suitable. Other utilizable dewatering or drying equipment includes clarifiers, paste thickeners, gravity belt thickeners, belt presses, screens, sieve bends, DSM screens, vacuum assisted screens, filter thickeners, washing thickeners, centrifuges and various combinations of these.

Looking back in the flow sheet, slurry stream 50 is produced by extraction plant 42 and cyclone separator 44. However, the fine particle stream delivered to mixer 52 may additionally or alternatively issue from any source, including an MFT (mature fine tailings) slurry pond 74. The slurry in pond 74 may have a solids concentration of about 35% by weight. That could be combined in mixer apparatus 52 with a coarse sands slurry 54 with solids in a concentration of about 68%. The resulting composite slurry 58 preferably has a coarse to fine ratio of between about 2 and about 3.

In order to reduce the amounts of requisite coarse sands particles 54 and new or fresh SAP, semi-solid composition 76 may be fed back or recycled to blending device or mixer 62 from the disposal area 70. The feedback composition 76 may have had an air-drying or consolidation period of many days, generally depending on climate conditions, at the disposal station prior to being conveyed back to mixer 62. Pursuant to this option, the mixing of superabsorbent polymer 64 with composite slurry 58 includes adding a semi-solid composition of already treated, somewhat dried solids including somewhat reconditioned or regenerated superabsorbent polymer to the composite slurry.

As depicted in FIG. 2, the present process contemplates the operation of several machines at respective locations: (a) blender or mixer apparatus 52 combines coarse particles 54 with the fine particle slurry 50 to generate composite slurry 58, (b) dewatering or separating apparatus 60 generally extracts water from composite slurry 58, preferably with the assistance of flocculant, (c) mixer or blender 62 mixes or blends SAP 64 with the thickened slurry 61 from dewatering or separating apparatus 60, and (d) pump 68 and/or pipeline 68, or possibly vehicular transport, conveys the stabilized composition 66 from an output of mixer 62 to disposal station 70. Station 70 may be a dedicated land site or the mining site from which the oil sands tailings originated.

Optionally, a pre-dewatering device (not illustrated) may be provided between mixer apparatus 52 and dewatering or drying apparatus 60 for possible dilution and/or implementing the addition of a flocculant/coagulant where the sands-to-fines ratio in composite slurry 58 may be about 3.

It is to be observed that the thickened slurry or sludge 61 takes the form of a paste that may be conveyed from dewatering or separating apparatus 60 to the SAP mixer 62 by pipeline. A sufficient quantity of superabsorbent polymer (SAP) 64 is mixed or blended in with the paste 61 via mixer 62 so that the composition 66 is a conveyable, non-segregating product having a resistance to breakdown due to the shear forces associated with pumping and/or pipeline transport as may be determined by certain various particle segregation tests, one of which is discussed in greater detail further on herein. Mixer 62 may take the form of a blender, pump, agglomerator or pug mill. The semi-solid material 66 may be deposited in the disposal area 70 by a conveyor-stacker system.

The addition of coarse sand particles 54 to fine tailing slurry 50 in a proper ratio is deemed necessary in order to generate a sufficient amount of appropriately sized pores or interstices that facilitate the entry of the SAP 64 into, and/or mixing with, the thickened slurry paste 61 and causing the water to be tied up or bound in a manner to thereby produce a shear stable, non-segregating material 66.

The various particle segregation settling tests discussed above include a standard particle segregation settling test known in the oil sands industry. This test is based on the Segregation Index which is, in turn, based on a segregating/non-segregating boundary. The segregating/non-segregating boundary defines the segregation or preferential settling of sand or coarse particles in a clay/sands or fines/coarse slurry. A slurry with a Fines Capture Index, as determined from a standard segregation test, of less than 95 is classified as “Segregating”. A slurry can be variously rendered as non-segregating, thereby increasing its Fines Capture Index to 95 or more, by, for example, increasing the solids content of the slurry and/or by the addition of suitable chemical reagents/flocculants which help bind the sands and fines together such that the preferential settling is reduced.

The present invention reduces the time to cause self-weight consolidation or compaction of a tailings product whereby a trafficable material is produced. In addition, the invention contemplates the elimination of sand tailings drying ponds. Thus, the impact of oil sands mining on the natural landscape is substantially reduced. In shortening the consolidation time of oil sands tailings and eliminating the necessity for tailings pond management, the present invention decreases costs and enhances profitability.

SAP used in the present invention may take the form of any and various cross-linked acrylic-acrylamide co-polymers (may be potassium neutralized) and, although usually used in particulate or granular form, may be used in the various forms discussed previously.

It is to be recognized that one may also vary the average size of any such SAP particles or granules. Generally, SAP particle sizes within a range of about 200-800 microns will result in a suitably accelerated drying time. A particular superabsorbent polymer suitable for carrying out the method of the present invention is sold under the designation Waste Lock® 770 by M² Polymer Technologies, Inc., of West Dundee, Ill. (www.m2polymer.com).

The present invention is useful for facilitating the transport, disposal and deposition of all manner of tailings or sludges that are difficult to dewater. Other tailings that are suitable for treatment by the present process include fine clays, red mud, phosphate fines, coal refuse, and fly ash. While the coarse particles may typically take the form of sand particles, it is contemplated that any coarse particle would suffice, whether inorganic or organic, whether crystalline or molecular.

Furthermore, a contractor or other entity may provide, or be hired to provide, a sludge or slurry stabilizing method such as the method disclosed in the present specification and shown in FIG. 2. For instance, the contractor may receive a bid request for a project related to designing a system for stabilizing a tailings stream or may offer to design such a method and accompanying system. The contractor may then provide a tailings treatment method such as the method discussed above. The contractor may provide such a method by selling the method or by offering to sell that method, and/or the various accompanying parts and equipment to be used with and/or for said method. The contractor may provide a method and/or related equipment that is configured to meet the design criteria of a client or customer. The contractor may subcontract the fabrication, delivery, sale, or installation of a component of, or of any of the devices or of other devices contemplated for use with such a method. The contractor may also survey a site and design or designate one or more storage areas for disposing of the material. The contractor may also maintain, modify or upgrade the provided devices and their use within the general method. The contractor may provide such maintenance or modifications by subcontracting such services or by directly providing those services.

Although the invention has been described in terms of particular embodiments and applications, one of ordinary skill in the art, in light of this teaching, can certainly generate additional embodiments and modifications without departing from the spirit of or exceeding the scope of the claimed invention. For instance, gypsum may be added to the composition in mixer 62. Accordingly, it is to be understood that the drawings and descriptions herein are proffered by way of example to facilitate comprehension of the invention and should not be construed to limit the scope thereof which is only defined by the broadest possible interpretation of the appended claims and their equivalents.

What is claimed is:

1. A physical stabilizing method comprising: combining coarse particles with a slurry of fine particles to generate a composite slurry having a substantially predetermined ratio of coarse particles to fine particles; and subsequently mixing superabsorbent polymer with said composite slurry in an amount effective to produce a shear stable, non-segregating composition.

2. The method defined in claim 1, further comprising dewatering said composite slurry prior to the mixing of said superabsorbent polymer with the now dewatered composite slurry.

3. The method defined in claim 2 wherein the dewatering of said composite slurry includes diluting and then flocculating said composite slurry.

4. The method defined in claim 2 wherein the dewatering of said composite slurry further includes processing said composite slurry in a dewatering device.

5. The method defined in claim 4 wherein said dewatering device is taken from the group consisting of a gravity thickener, a clarifier, a paste thickener, a gravity belt thickener, a belt press, a screen, a sieve bend, a DSM screen, a vacuum assisted screen, a filter thickener, a washing thickener, and a centrifuge.

6. The method defined in claim 1 wherein said predetermined ratio is between about 0.5 and about 4 by weight.

7. The method defined in claim 6 wherein said coarse particles comprise sand particles and said fine particles comprise a slurry of fine tailings originating from oil sands tailings, said predetermined ratio of coarse to fine being between 2 and 4 by weight.

8. The method defined in claim 7, further comprising generating said slurry of fine tailings from an extraction slurry by separating out coarse sand particles from said extraction slurry, the coarse particles combined with said slurry of fine tailings to produce said composite slurry being at least a portion of the coarse sand particles separated from said extraction slurry.

9. The method defined in claim 1 wherein the mixing of superabsorbent polymer with said composite slurry includes adding a semi-solid composition of solids and superabsorbent polymer to said composite slurry.

10. The method defined in claim 9 wherein the adding of the semi-solid composition is a recycling of the semi-solid composition.

11. The method defined in claim 1 wherein the combining of said coarse particles with said slurry of fine particles includes mixing or blending said coarse particles into said slurry of fine particles.

12. The method defined in claim 1, further comprising transporting said shear stable, non-segregating composition to a predetermined location and depositing said shear stable, non-segregating composition in a disposal area at said location.

13. The method defined in claim 1 wherein said slurry of fine particles includes tailings taken from the group consisting of mature fine tailings, new fine tailings, whole tailings, and composite tailings.

14. The method defined in claim 1 wherein particles in said slurry of fine particles have a diametrical size less than about 44 microns and wherein said coarse particles have a diametrical size greater than about 44 microns.

15. The method defined in claim 1, further comprising adjusting the pH of the composite slurry before mixing the composite slurry with the superabsorbent polymer.

16. The method defined in claim 1, further comprising washing the composite slurry before mixing the composite slurry with the superabsorbent polymer.

17. The method defined in claim 1 wherein the superabsorbent polymer is in particle form.

18. The method defined in claim 17 wherein the particle size of the admixed superabsorbent polymer particles is in the range of about 200-800 microns.

19. The method defined in claim 2 wherein the superabsorbent polymer is in particle form and wherein said superabsorbent polymer particles are mixed with the dewatered composite slurry in the ratio of about 0.2 to 6 lbs. by weight of dry solids in the dewatered composite slurry.

20. A method for treating tailings comprising: combining coarse particles with a slurry of fine particles to generate a composite slurry having a substantially predetermined ratio of coarse particles to fine particles; diluting said composite slurry; flocculating said diluted composite slurry; dewatering the diluted and then flocculated composite slurry; and subsequently mixing superabsorbent polymer with the diluted and then flocculated and dewatered composite slurry to produce a shear stable, non-segregating composition.

21. The method defined in claim 20 wherein the dewatering of said diluted and then flocculated composite slurry includes processing said flocculated composite slurry in a dewatering device.

22. The method defined in claim 21 wherein said dewatering device is taken from the group consisting of a gravity thickener, a clarifier, a paste thickener, a gravity belt thickener, a belt press, a screen, a sieve bend, a DSM screen, a vacuum assisted screen, a filter thickener, a washing thickener, and a centrifuge.

23. The method defined in claim 20 wherein said predetermined ratio is between about 0.5 and 4 by weight.

24. The method defined in claim 20 wherein said coarse particles comprise sand particles and said fine particles comprise a slurry of fine tailings originating from oil sands tailings, said predetermined ratio being between 2 and 4 by weight.

25. The method defined in claim 24, further comprising generating said slurry of fine tailings from an extraction slurry by separating out coarse sand particles from said extraction slurry, the coarse particles combined with said slurry of fine tailings to produce said composite slurry being at least a portion of the coarse sand particles separated from said extraction slurry.

26. The method defined in claim 20 wherein the mixing of superabsorbent polymer with said composite slurry includes adding a semi-solid composition of solids and superabsorbent polymer to said composite slurry.

27. The method defined in claim 26 wherein the adding of the semi-solid composition is a recycling of the semi-solid composition.

28. The method defined in claim 20 wherein the combining of said coarse particles with said slurry of fine particles includes mixing or blending said coarse particles into said slurry of fine particles.

29. The method defined in claim 20, further comprising transporting said shear stable, non-segregating composition to a predetermined location and depositing said shear stable, non-segregating composition at said location.

30. The method defined in claim 20 wherein said slurry of fine particles includes tailings taken from the group consisting of mature fine tailings, new fine tailings, whole tailings, and composite tailings.

31. The method defined in claim 20 wherein particles in said slurry of fine particles have a diametrical size of less than about 44 microns and wherein said coarse particles have a diametrical size greater than about 44 microns.

32. The method defined in claim 20, further comprising adjusting the pH of the composite slurry prior to mixing the superabsorbent polymer with the composite slurry.

33. The method defined in claim 20, further comprising washing the composite slurry prior to mixing the superabsorbent polymer with the composite slurry.

34. The method defined in claim 20 wherein the superabsorbent polymer is in the form of particles.

35. The method defined in claim 34 wherein the particle size of the superabsorbent polymer particles is in the range of about 200-800 microns.

36. The method defined in claim 34 wherein the superabsorbent polymer particles are mixed with the dewatered composite slurry in the ratio of about 0.2 to 6 lbs. by weight of dry solids in the dewatered composite slurry.
